(19) United States
(12) Patent Application Publication
(10) Pub. No.: US 2024/0189918 A1
(43) Pub. Date: Jun. 13, 2024

(54) INDEXABLE CUTTING TOOL AND CUTTING INSERT

(71) Applicant: TUNGALOY CORPORATION, Fukushima (JP)

(72) Inventors: Jun OTSUKA, Fukushima (JP); Katsura MOCHIZUKI, Fukushima (JP)

(73) Assignee: TUNGALOY CORPORATION, Fukushima (JP)

(21) Appl. No.: 18/531,631

(22) Filed: Dec. 6, 2023

(30) Foreign Application Priority Data
Dec. 8, 2022 (JP) 2022-196125

(51) Int. Cl. B23B 27/10; B23B 27/16

(52) U.S. Cl. CPC B23B 27/10; B23B 27/1611

(57) ABSTRACT

To achieve more efficient cooling and lubrication by making a coolant more reliably and directly reach a machining point even in machining such as inner diameter grooving of a small diameter or grooving of a narrow groove width with which it is difficult for a coolant to reach a machining point.

An indexable cutting tool that adopts a structure in which a cutting insert including cutting edges is removably mounted, by a set screw, on an insert mounting seat at an axial direction leading end part of a tool body includes: a coolant flow passage for coolant supply, the coolant flow passage being provided to the tool body; an opening part that is provided to the insert mounting seat; and a recessed part that forms a flow passage in which at least part of the coolant discharged from the opening part flows, the recessed part being provided to the cutting insert.

### BACKGROUND

### Field

The present invention relates to an indexable cutting tool and a cutting insert.

### Description of Related Art

As conventional tools each supplying a coolant toward a portion (machining point) at which a cutting insert cuts a workpiece, there are proposed an indexable inner diameter grooving tool (see, for example, Patent Publication JP 2010-179380A) that adopts a structure for jetting a coolant from a gap between a cutting insert and a seat, and tools (see, for example, Patent Publication JP 2013-107196A and Japanese Translation of PCT Application No. 2013-519537) that adopt structures including recessed parts of cutting inserts as part of coolant flow passages.

### SUMMARY

However, there is a case where, when a cutting machining mode is changed or when a workpiece of a different shape is a machining target, a coolant does not sufficiently reach a machining point. For example, cutting machining such as inner diameter grooving of a small diameter or grooving of a narrow groove width usually makes it difficult for a coolant to reach a machining point.

It is therefore an object of the present invention to provide an indexable cutting tool and a cutting insert that can achieve more efficient cooling and lubrication by making a coolant more reliably and directly reach a machining point even in machining such as inner diameter grooving of a small diameter or grooving of a narrow groove width, with which it is difficult for a coolant to reach a machining point.

One aspect of the present invention is an indexable cutting tool that adopts a structure in which a cutting insert including a cutting edge is removably mounted, by a set screw, on an insert mounting seat at an axial direction leading end part of a tool body, and includes: a coolant flow passage for coolant supply, the coolant flow passage being provided to the tool body; an opening part of the coolant flow passage, the opening part being provided to the insert mounting seat; and a recessed part that forms a flow passage in which at least part of the coolant discharged from the opening part flows, the recessed part being provided to the cutting insert.

The indexable cutting tool according to this aspect can form a portion (coolant discharge part) at which the recessed part provided to the cutting insert and the opening part provided to the insert mounting seat discharge in cooperation the coolant to the cutting edge. In such a case, the coolant can be supplied from a position closer to the cutting edge than in the conventional techniques, so that it is possible to achieve more efficient cooling and lubrication more than ever, and eventually achieve a longer operational life of the tool and improvement of quality of a machined surface.

In the above indexable cutting tool, the opening part and the recessed part may be provided to form a coolant discharge part that faces toward the cutting edge.

In the above indexable cutting tool, the coolant discharge part may be formed in a shape with which the coolant is discharged toward part of the cutting edge.

In the above indexable cutting tool, the coolant discharge part may be formed in a shape with which the opening part and the recessed part are combined to form a substantially circular shape.

In the above indexable cutting tool, the recessed part may have a dimple shape.

In the above indexable cutting tool, the recessed part may be formed as a hemispherical dimple.

In the above indexable cutting tool, the recessed part may be provided such that a side of the recessed part closer to the cutting edge is deeper.

In the above indexable cutting tool, part of the opening part of the coolant flow passage may have a dimple shape.

In the above indexable cutting tool, the cutting insert may be provided with a plurality of the recessed parts.

In the above indexable cutting tool, the cutting insert has a symmetrical shape, with different cutting edges being able to be used even in a state where the cutting insert is turned about a predetermined axis or in a state where a top surface and a back surface are switched over.

Another aspect of the present invention is a cutting insert that adopts a structure that can be removably mounted using a set screw on an insert mounting seat at an axial direction leading end part of a tool body of an indexable cutting tool including a coolant flow passage for coolant supply, and the cutting insert includes a recessed part provided at a position corresponding to an opening part of the coolant flow passage, and forms a flow passage in which at least part of the coolant discharged from the opening part flows in a state where the cutting insert is mounted on the insert mounting seat.

In the above cutting insert, the recessed part may be provided such that a side of the recessed part closer to the cutting edge is deeper.

### BRIEF DESCRIPTION OF DRAWINGS

FIG. 1 is a view illustrating from a side part a leading end portion of an indexable cutting tool according to an embodiment of the present invention;

FIG. 2 is a view illustrating the leading end portion of the indexable cutting tool from a side part provided with a coolant discharge part;

FIG. 3 is a perspective view illustrating the leading end portion of the indexable cutting tool;

FIG. 4 is a perspective view illustrating an example of a cutting insert provided with recessed parts;

FIG. 5 is a perspective view illustrating a leading end part of a shank (tool body) provided with an opening part of a coolant flow passage;

FIG. 6 is a perspective view illustrating a leading end portion of an indexable cutting tool according to a second embodiment of the present invention;

FIG. 7 is a view illustrating from a side part a leading end portion of the indexable cutting tool illustrated in FIG. 6;

FIG. 8 is a view illustrating the leading end portion of the indexable cutting tool illustrated in FIG. 6 from a side part provided with a coolant discharge part;

FIG. 9 is a perspective view illustrating the leading end portion of the indexable cutting tool employing a configuration of, for example, cutting edges different from that illustrated in FIG. 6;

FIG. 10 is a perspective view illustrating a leading end portion of an indexable cutting tool according to a third embodiment of the present invention;

FIG. 11 is a perspective view illustrating an example of a cutting insert provided with a plurality of recessed parts; and

FIG. 12 is a perspective view illustrating a leading end part of a shank (tool body) provided with a plurality of opening parts of coolant flow passages.

### DETAILED DESCRIPTION

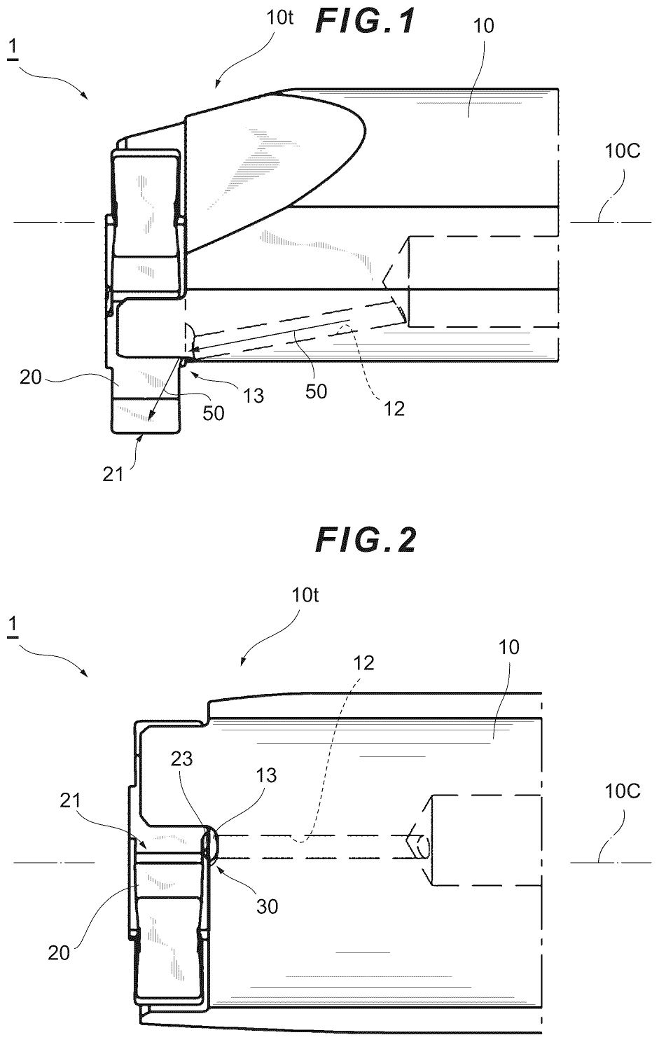

Hereinafter, preferred embodiments of an indexable cutting tool and a cutting insert according to the present invention will be described in detail with reference to the drawings (see, for example, FIG. 1).

A indexable cutting tool 1 according to the present invention is a cutting tool that adopts a structure that a cutting insert 20 can be mounted and removed using a set screw 40 on and from an insert mounting seat 11 at a leading end part 10t of a shank 10 that is a tool body, and a cutting edge (edge end) 21 can be exchanged by replacing the cutting insert 20 and differing an orientation of the cutting insert 20 (see, for example, FIG. 1).

The shank 10 is a member that is the tool body of the indexable cutting tool 1, and has a shape that extends along a central axis 10C of the shank 10. The insert mounting seat 11 is provided at the leading end part 10t in a direction (axial direction) along the central axis 10C (see FIG. 5). This insert mounting seat 11 is provided with a female screw part 14 to which the set screw 40 is screwed, and the cutting insert 20 can be mounted thereon and removed therefrom using the set screw 40. Although a specific aspect of the female screw part 14 is not limited in particular, in an example, the female screw part 14 that extends along the central axis 10C is provided to the insert mounting seat 11 in the indexable cutting tool 1 according to the present embodiment (see FIG. 5).

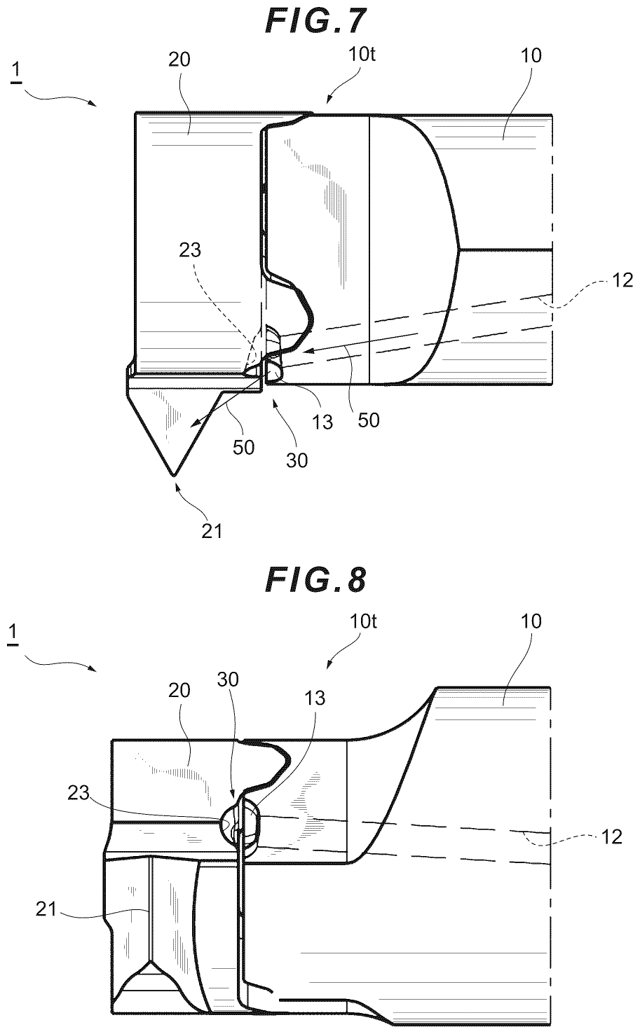

The shank 10 is provided with a coolant flow passage 12 and an opening part 13. The coolant flow passage 12 is a flow passage for supplying a coolant toward a portion, that is, a machining point at which a workpiece (not illustrated) is cut, and extends from a base end part (not illustrated) of the shank 10 toward the leading end part 10t (see, for example, FIG. 1). The opening part 13 is an opened portion of the coolant flow passage 12 on a side of the leading end part 10t, and is a discharge port of the coolant (FIGS. 1 and 7 schematically illustrate the coolant (reference numeral 50) by arrows indicating a flow of the coolant). In the present embodiment, the insert mounting seat 11 is provided with this opening part 13 (see FIG. 5).

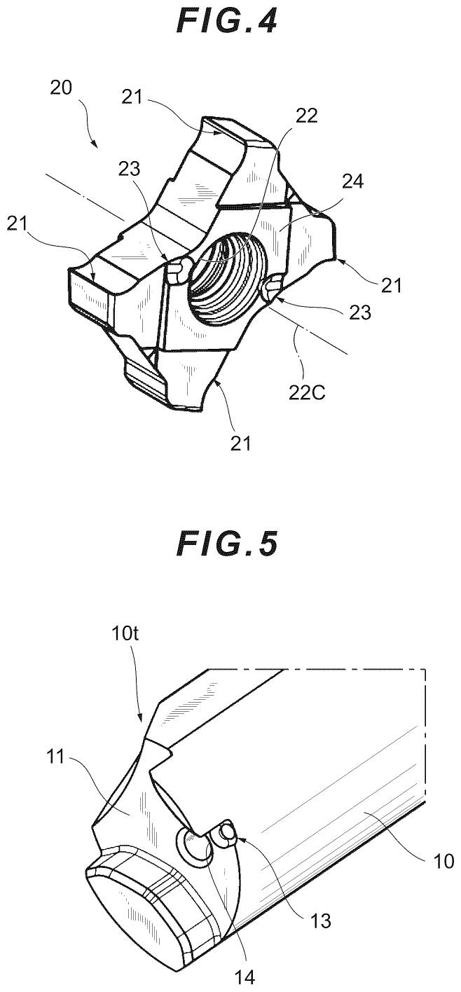

The cutting insert 20 includes cutting edges 21 and a screw hole 22. The single cutting insert 20 may be provided with the plurality of cutting edges 21 (see, for example, FIG. 4). The screw hole 22 is provided at a substantially center of the cutting insert 20. When being mounted on the insert mounting seat 11 using the set screw 40, the cutting insert 20 according to the present embodiment is formed such that the cutting edges 21 face toward a radial direction outer side as seen from the central axis 10C of the shank 10 (see, for example, FIGS. 1 and 2).

The cutting insert 20 is provided with recessed parts 23 to form the flow passage in which at least part of the coolant 50 discharged from the opening part 13 of the coolant flow passage 12 flows (see, for example, FIG. 4). These recessed parts 23 and opening part 13 of the shank 10 are provided to face toward the cutting edges 21 in a state where the cutting insert 20 is mounted on the insert mounting seat 11, and form a coolant discharge part 30 having such a shape that the coolant 50 is discharged toward at least part of the cutting edges 21. According to this indexable cutting tool 1, when the cutting insert 20 is mounted on the insert mounting seat 11, the opening part 13 and the recessed parts 23 can cooperate with each other to discharge the coolant 50 toward the cutting edges 21. Moreover, according to the indexable cutting tool 1 including this coolant discharge part 30, it is possible to supply the coolant 50 from a position close to the cutting edges 21 compared to conventional cutting tools that adopt structures including recessed parts only in shanks. Consequently, it is possible to achieve more efficient cooling and lubrication than the conventional techniques, and eventually achieve a longer operational life of a tool and improvement of quality of a machined surface.

Hereinafter, the above structure will be described in order as (1) a first embodiment where the above structure is applied to the indexable cutting tool 1 that adopts the structure that the cutting insert 20 including the four cutting edges 21 is mounted on the shank 10 and is used for inner diameter grooving machining and the like, (2) a second embodiment that the above structure is applied to an inner diameter machining thread cutting tool or an inner diameter machining front turning tool, and (3) a third embodiment where the above structure is provided with a plurality of the opening parts 13 of the coolant flow passages 12 of the shank (tool body) 10 and a plurality of the recessed parts 23 of the cutting insert 20.

### First Embodiment

The indexable cutting tool 1 according to the present embodiment is a tool used for inner diameter grooving machining and the like, and includes the shank 10, and the cutting insert 20 that is mounted on the insert mounting seat 11 at the leading end part 10t of the shank 10 using the set screw 40 (see FIGS. 1 to 5). The cutting insert 20 adopts a structure that can be used by being turned 180° about an axis 22C passing the center of the screw hole 22, and can be used by reversing and switching the top and the bottom, and includes two cutting edges on a single surface and the four cutting edges 21 in total on both surfaces (see FIG. 4).

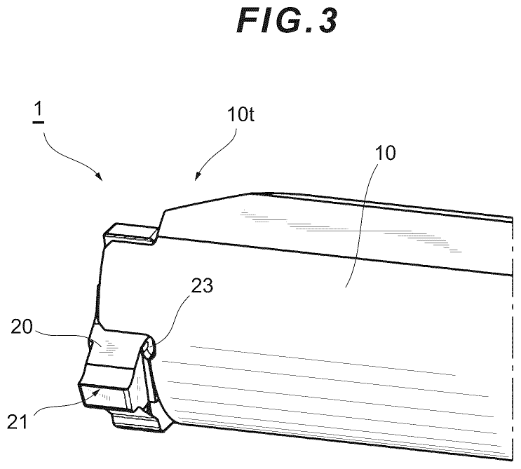

The insert mounting seat 11 of the shank 10 is provided with the opening part 13 of the coolant flow passage 12 (see FIGS. 2 and 5). A portion of a bottom surface (a face in contact with the insert mounting seat 11) 24 of the cutting insert 20 that faces this opening part 13 in a state where the cutting insert 20 is mounted on the insert mounting seat 11 is provided with the recessed parts 23 (see, for example, FIGS. 3 and 4). These opening part 13 and recessed parts 23 are provided to form the coolant discharge part 30 that can discharge the coolant 50 supplied through the coolant flow passage 12 toward at least part of the cutting edges 21, and, preferably, a machining point (a portion at which the cutting insert 20 cuts a workpiece) (see FIG. 1). These opening part 13 and recessed parts 23 are preferably formed in a shape that can make the coolant 50 reliably reach the cutting edges 21 particularly even when machining such as inner diameter grooving of a small diameter or grooving of a narrow groove width, with which it is difficult for the coolant 50 to reach a machining point, is performed. In an example, the opening part 13 according to the present embodiment has a shape part of which has a dimple shape, and whose portion facing the cutting edges 21 is widely opened (see, for example, FIG. 5). Furthermore, from a similar viewpoint, the recessed parts 23 according to the present embodiment have shapes that are formed as hemispherical dimples, and sides of the recessed parts 23 closer to the cutting edges 21 are deeper (see, for example, FIG. 4). The opening part 13 and the recessed parts 23 may be provided to form the coolant discharge part 30 that becomes substantially circular when combined. In this case, it is possible to reduce the resistance at a time of jetting the coolant 50 as much as possible, and increase a flow rate.

### Second Embodiment

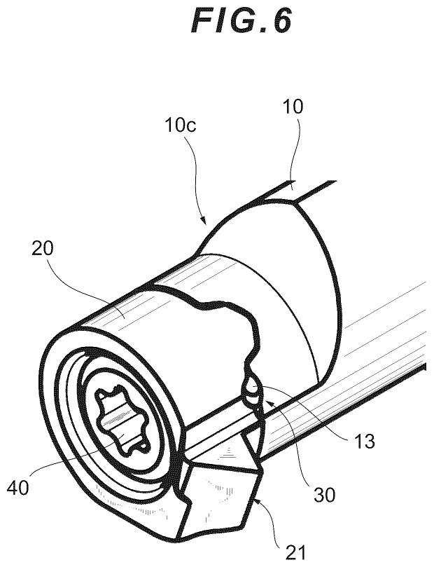

Hereinafter, an example where the present invention is applied to the indexable cutting tool 1 other than the inner grooving tool will be described (see FIGS. 6 to 9). FIGS. 6 to 8 are views illustrating an example of the inner dimeter machining thread cutting tool to which the present invention has been applied. According to this indexable cutting tool 1, the opening part 13 of the coolant flow passage 12 is provided at the leading end part 10t of the shank 10, and the recessed parts 23 are provided at portions of the bottom surface 24 of the cutting insert 20 that face this opening part 13 in a state where the cutting insert 20 is mounted on the insert mounting seat 11 (see FIGS. 6 to 8). These opening part 13 and recessed parts 23 are provided to form the coolant discharge part 30 that can discharge the coolant 50 supplied through the coolant flow passage 12 toward at least part of the cutting edges 21, and, preferably, a machining point (see, for example, FIG. 7).

FIG. 9 is a view illustrating an example of the inner diameter machining front turning tool to which the present invention has been applied. Similar to the case of the above-described inner diameter machining thread cutting tool, according to this indexable cutting tool 1, too, the opening part 13 of the coolant flow passage 12 is provided at the leading end part 10t of the shank 10, and the recessed parts 23 are provided at portions of the bottom surface 24 of the cutting insert 20 that face this opening part 13 in a state where the cutting insert 20 is mounted on the insert mounting seat 11 (see FIG. 9). These opening part 13 and recessed parts 23 are provided to form the coolant discharge part 30 that can discharge the coolant 50 supplied through the coolant flow passage 12 toward at least part of the cutting edges 21, and, preferably, a machining point.

### Third Embodiment

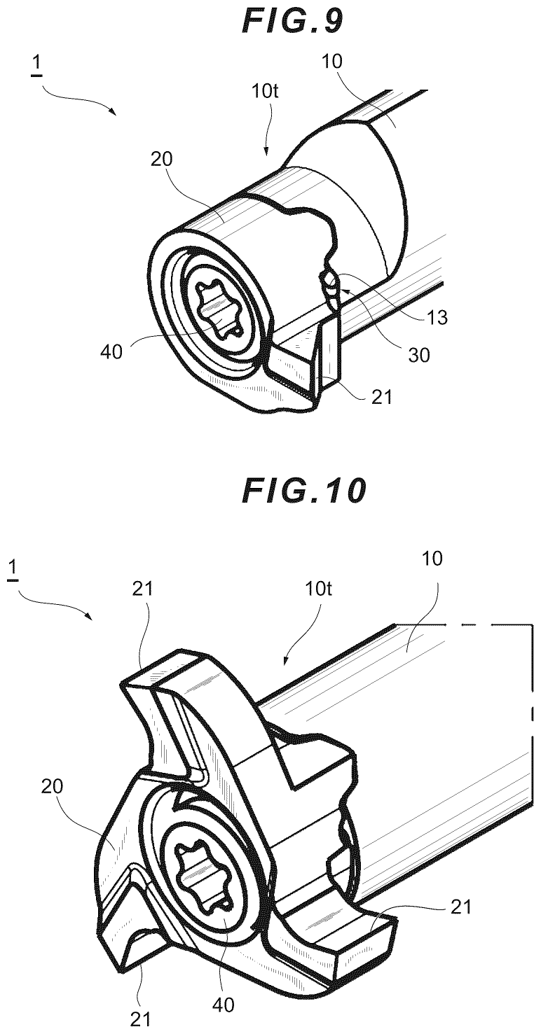

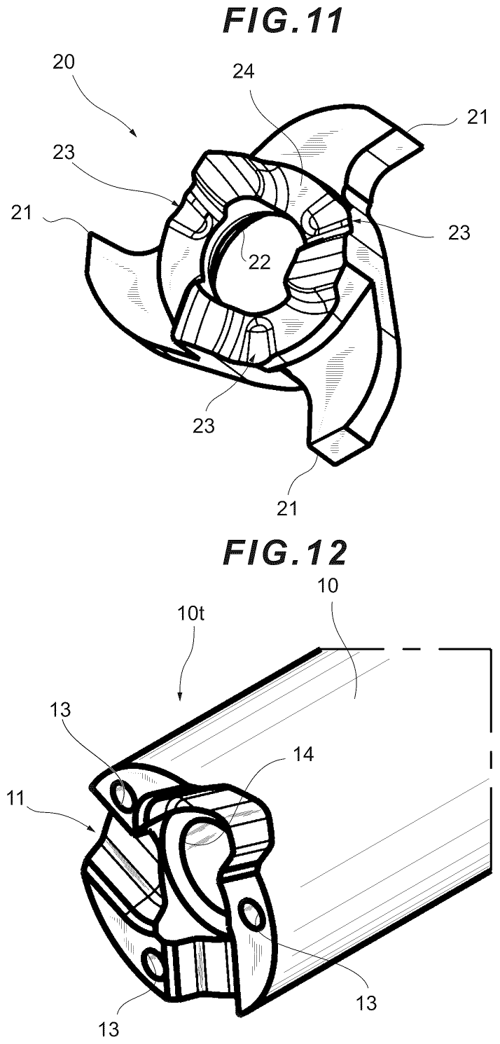

Hereinafter, an example where a plurality of the coolant discharge parts 30 are provided to the indexable cutting tool 1 will be described (see FIGS. 10 to 12). Note that the present embodiment will describe a case targeting at the indexable cutting tool 1 that is a rotary cutting tool (such as a milling tool) instead of a turning tool. According to this indexable cutting tool 1, the opening parts 13 of the coolant flow passages 12 are provided at portions of the insert mounting seat 11 at the leading end part 10t of the shank 10 that are in contact with the bottom surface (a flat portion in this case) 24 of the cutting insert 20. In the present embodiment, the three opening parts 13 are arranged at equal intervals every 120° in the radial direction (see FIG. 12). Each opening part 13 is provided at an end part of an insert flow passage (not illustrated in FIGS. 10 to 12) passing inside the shank 10. Furthermore, the three recessed parts 23 in total are provided at portions of the bottom surface 24 of the cutting insert 20 that face these opening parts 13 in a state where the cutting insert 20 is mounted on the insert mounting seat 11 (see FIGS. 6 to 8). This cutting insert 20 includes the three cutting edges 21 arranged every 120°. Each of the above-described opening parts 13 and recessed parts 23 is provided to form the coolant discharge parts 30 having such shapes that the coolant 50 is discharged toward the cutting edge 21 located at the nearest position.

Note that the above-described embodiments are the preferred embodiments of the present invention, yet are not limited thereto, and can be variously modified and carried out without departing from the gist of the present invention. For example, although, when the cutting insert 20 according to each of the above-described embodiments is mounted on the insert mounting seat 11 using the set screw 40, the cutting edges 21 is in a state facing toward the radial direction outer side as seen from the central axis 10C of the shank 10, this state is merely an example. Although not illustrated in particular, it goes without saying that it is possible to apply the present invention to a case, too, targeting at the cutting insert 20 that adopts a structure that, when the cutting insert 20 is mounted on the insert mounting seat 11 using the set screw 40, the cutting edges 21 face toward the axial direction (the direction along the central axis 10C), and discharge the coolant 50 toward the cutting edges 21.

The present invention is suitably applied to an indexable cutting tool and a cutting insert.

What is claimed is:

1. An indexable cutting tool that adopts a structure in which a cutting insert including a cutting edge is removably mounted, by a set screw, on an insert mounting seat at an axial direction leading end part of a tool body, the indexable cutting tool comprising:
a coolant flow passage for coolant supply, the coolant flow passage being provided to the tool body;
an opening part of the coolant flow passage, the opening part being provided to the insert mounting seat; and
a recessed part that forms a flow passage in which at least part of the coolant discharged from the opening part flows, the recessed part being provided to the cutting insert.

2. The indexable cutting tool according to claim 1, wherein the opening part and the recessed part are provided to form a coolant discharge part that faces toward the cutting edge.

3. The indexable cutting tool according to claim 2, wherein the coolant discharge part is formed in a shape with which the coolant is discharged toward part of the cutting edge.

4. The indexable cutting tool according to claim 3, wherein the coolant discharge part is formed in a shape with which the opening part and the recessed part are combined to form a substantially circular shape.

5. The indexable cutting tool according to claim 1, wherein the recessed part has a dimple shape.

6. The indexable cutting tool according to claim 5, wherein the recessed part is formed as a hemispherical dimple.

7. The indexable cutting tool according to claim 4, wherein the recessed part is provided such that a side of the recessed part closer to the cutting edge is deeper.

8. The indexable cutting tool according to claim 1, wherein part of the opening part of the coolant flow passage has a dimple shape.

9. The indexable cutting tool according to claim 1, wherein the cutting insert is provided with a plurality of the recessed parts.

10. The indexable cutting tool according to claim 9, wherein the cutting insert has a symmetrical shape, with different cutting edges being able to be used even in a state where the cutting insert is turned about a predetermined axis or in a state where a top surface and a back surface are switched over.

11. A cutting insert that can be removably mounted using a set screw on an insert mounting seat at an axial direction leading end part of a tool body of an indexable cutting tool including a coolant flow passage for coolant supply,
wherein the cutting insert includes a recessed part provided at a position corresponding to an opening part of the coolant flow passage, and forms a flow passage in which at least part of the coolant discharged from the opening part flows in a state where the cutting insert is mounted on the insert mounting seat.

12. The cutting insert according to claim 11, wherein the recessed part is provided such that a side of the recessed part closer to the cutting edge is deeper.
